(19) United States
(12) Patent Application Publication
(10) Pub. No.: US 2024/0066956 A1
(43) Pub. Date: Feb. 29, 2024

(54) MOTOR VEHICLE WITH SCENTING DEVICE

(71) Applicant: Supair-Tel AG, Glattbrugg (CH)

(72) Inventor: Rudolf Heinrich GUGGENHEIM, Wollerau (CH)

(21) Appl. No.: 18/458,519

(22) Filed: Aug. 30, 2023

(30) Foreign Application Priority Data
Aug. 31, 2022 (EP) 22193043.1

(51) Int. Cl. B60H 3/00

(52) U.S. Cl. CPC B60H 3/0014; B60R 2011/0021

(57) ABSTRACT

A motor vehicle, in particular a passenger car, comprises an interior, a door and a scenting device with a scent. The scenting device is arranged and designed in such a way that the scenting device emits the scent only when the door is open. As a result, the user of the motor vehicle only perceives the scent when getting in and out of the vehicle and does not become accustomed to the scent while driving.

### FIELD OF THE INVENTION

The invention relates to a motor vehicle, in particular a passenger car, having an interior, a door and a scenting device, which comprises a scent. In addition, the invention relates to such a scenting device and to a method for replacing this scenting device.

### BACKGROUND

Scenting devices, which can be suspended in the vehicle interior, are known and comprise, for example, a material impregnated with a scent. Such devices are inexpensive to manufacture, but their scenting effect can be uneven and the scent body, which is usually suspended from the interior rear-view mirror, can obstruct visibility.

Furthermore, casings with scent are known which are attached to a ventilation grille in the interior of a vehicle. The casing for the scent has inlet openings so that air from the ventilation system flows into the casing, comes into contact with the scent and, enriched with scent molecules, leaves the casing through outlet openings. Such casing can be attached to and removed from the ventilation grille by means of a clamping part.

After a certain period of time, the occupants become accustomed to the scent and no longer consciously perceive it. The scenting device no longer fulfils its purpose.

### SUMMARY

The object is to provide a motor vehicle with a scenting device, whereby the users of the motor vehicle can perceive the scent of the scenting device well.

This object is solved by a motor vehicle according to the independent claim(s). Accordingly, a motor vehicle, in particular a passenger car, comprises an interior, a door and a scenting device. The scenting device comprises a scent. The scenting device is arranged and configured in such a way that the scenting device emits the scent only when the door is open.

The scent is emitted only for a short time, namely while the door is open. When the door is closed, no scent is emitted. In particular, the scent emits by means of a single push triggered by the opening of the door or permanently while the door remains open.

Since the scenting device does not emit any scent when the door is closed and the scent does not settle in the seats or other components of the motor vehicle due to the short emission period when the door is open, the occupants do not perceive the scent during their stay in the interior of the motor vehicle, but only during getting in and out of the motor vehicle. The occupants are thus only confronted with the scent for a short time, do not become accustomed to it, in particular not during a long journey, and perceive the scent all the more consciously during the short emission period, i.e., during getting in and out of the motor vehicle.

Advantageously, the scenting device is arranged and designed in such a way that the scenting device is at least partially exposed when the door is open and covered, in particular completely covered, when the door is closed. If the scenting device is covered when the door is closed, the emission of scent can be prevented in a simple manner when the door is closed. If the scenting device is exposed by opening the door, scent is emitted immediately.

In particular, the scenting device is arranged and designed in such a way that the scenting device is not visible or accessible to a passenger as well as to a person outside the motor vehicle when the door is closed.

Advantageously, the scenting device is arranged and designed in such a way that;
a closing movement of the door alone covers the scenting device, and
an opening movement of the door alone exposes the scenting device.

This configuration has the advantage that, on the one hand, a regular emission of scent is guaranteed for short periods of time. On the other hand, the user controls the emission of the scent himself, namely by opening and closing the door, but unconsciously, and this combined with the advantage that the scent is emitted just when the user is in the vicinity and can consciously perceive the scent.

In particular, the scenting device is arranged and configured such that the scenting device is in contact with a door frame as well as in contact with the door when the door is closed. The door frame is to be understood as the counterpart to the door. The door frame frames the door in the closed position, while the door moves out of the door frame when the door is opened. A component of the door frame can be, for example, the A, B, C or D pillars, or also the door sill.

The scenting device is thus surrounded by the door and door frame when the door is closed, or the door and door frame clamp the scenting device when the door is closed.

Advantageously, the scenting device is arranged on a narrow side of the door, in particular fastened to the narrow side, in particular by means of adhesion, in particular by means of a double adhesive strip. The narrow side of the door is the side of the door that extends over the thickness of the door. Normally, the narrow side of the door is in contact with or surrounded by the door frame when the door is closed. The arrangement of the scenting device on the narrow side is inconspicuous, but still easily accessible when the door is open, so that the scenting device can be replaced in a simple manner.

Advantageously, the scenting device is arranged on the door frame of the motor vehicle, in particular attached to the door frame, in particular by means of adhesion, in particular by means of a double adhesive strip. In this configuration, too, the scenting device is positioned inconspicuously but is easily accessible when the door is open.

In particular, the scenting device is arranged on a surface of the body, which is covered by the door, in particular by the narrow side of the door, when the door is closed.

By “door” may be meant in particular a side door or a boot door. The scenting device can thus be mounted in such a way that the user not only perceives the scent when getting in and out of the car, but also when the boot door is open, while inserting objects into or removing objects from the boot.

Advantageously, the door has a window and the scenting device is arranged below the window. This arrangement is particularly advantageous because the windows on the doors themselves do not have to be framed and in this case the installation of the scenting device in the area of the window would be problematic.

Furthermore, the object is to provide a scenting device which can be installed in a motor vehicle in such a way that the users of the motor vehicle perceive the scent of the scenting device well.

This object is solved by a scenting device which comprises a scent and has a flat shape. The flat shape has a thickness which can be constant, in particular over the scenting device.

Advantageously, five times, in particular ten times, in particular twenty times, in particular forty times, the thickness is smaller than the longest extension, in particular rectilinear extension, of the scenting device. In other words, the scenting device is flat so that the thickness is significantly smaller than another extension of the scenting device.

The design of the scenting device as a flat component has the advantage that it can be easily fixed between the door and the door frame surrounding the door without the door or door frame having to have a recess for receiving the scenting device. In addition, such a scenting device can be easily mounted on any motor vehicle, in particular retrofitted.

Advantageously, the scenting device comprises a casing and a scent body. The casing serves to protect the scent body and to attach the scent body to the motor vehicle. The scent is stored in the scent body.

In particular, the casing is permeable to the scent, in particular the casing is perforated. The emission of scent from the scenting device is thereby ensured.

In particular, the scent body is corrugated to increase the surface area of the scent body. The scent can thus be emitted even better from the scent body.

The cover may, for example, be made of the material PVC (polyvinyl chloride). The scent body can, for example, consist of the material EVA (ethylene vinyl acetate), whereby the scent is injected into the plastic during injection moulding.

Advantageously, the scenting device is elastically curvable along its longest extension to at least a curvature of 1/100 mm-1, in particular to a curvature of at least 1/75 mm-1, in particular to a curvature of at least 1/50 mm-1. This has the advantage that the scenting device can be attached to curved surfaces of the car body or to curved surfaces of the door. The scenting device can be used flexibly.

Furthermore, it can be provided that the scenting device is replaced each time maintenance work is carried out on the vehicle in a motor vehicle workshop. The scent can be refilled, or the scenting device can be replaced completely.

### BRIEF DESCRIPTION OF THE DRAWINGS

Further embodiments, advantages and applications of the invention will be apparent from the dependent claims and from the following description based on the figures. The figures show:

FIGS. 1a and 1b a front view and a side view of a scenting device;

FIG. 1c a side view of the scent body of the scenting device;

FIG. 2 a motor vehicle with a scenting device mounted on the driver's door;

FIG. 3 a motor vehicle with a scenting device mounted on the driver's door frame;

FIG. 4 a motor vehicle with a scenting device mounted on the door of the rear seats;

FIG. 5 a motor vehicle with a scenting device mounted on the door frame of the door by the rear seats; and

FIG. 6 a motor vehicle with scenting devices mounted on the boot.

### DETAILED DESCRIPTION OF THE INVENTION

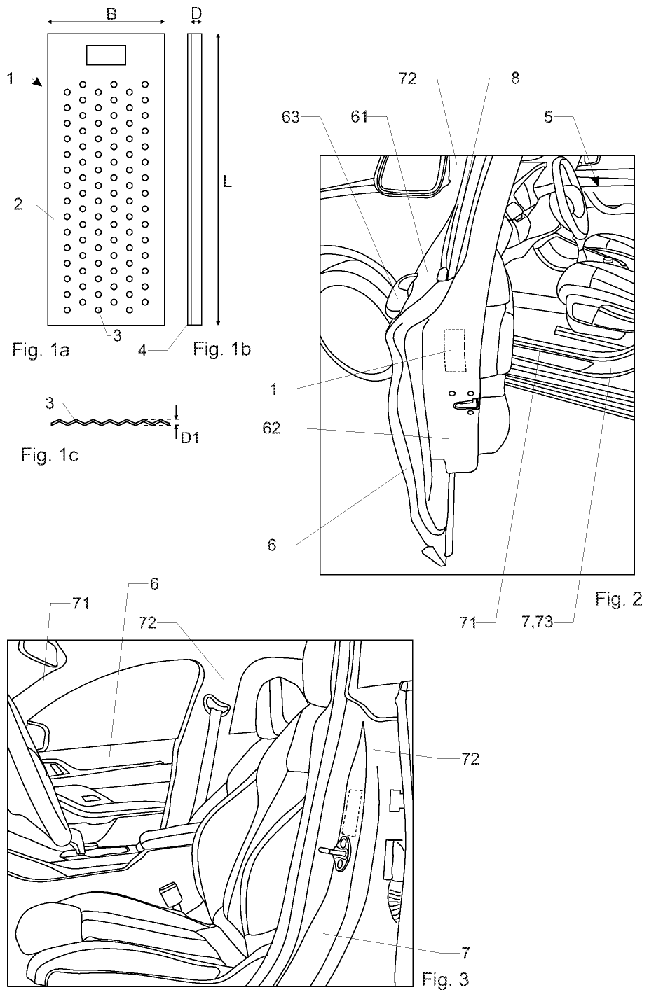

FIGS. 1a and 1b show a scenting device 1 according to the invention. It has a length L of 108 mm, a width B of 50 mm and a thickness D of 2.7 mm. The scenting device 1 thus has a flat shape, whereby the thickness D is substantially smaller than the longest extension of the scenting device 1. The longest extension corresponds to the diagonal across length L, width B and thickness D.

The scenting device 1 comprises a casing 2 and a scent body 3. The casing 2 is perforated, consists of the material polyvinyl chloride and encloses the scent body 3. FIG. 1c shows the scent body 3 without the casing 2 and has a thickness D1 of 2.3 mm. The scent body 3 consists of the material ethylene vinyl acetate and is filled with a scent. In addition, the scent body 3 is corrugated so that the surface is optimised for the emission of the scent. If the scent body 3 is not covered, it permanently emits scent to the outside through the perforated cover 2.

Due to the chosen materials and the small thickness, the scenting device 1 can be curved relatively easily, so that the scenting device 1 can also be easily attached to curved surfaces. An adhesive layer 4, in particular a double adhesive strip, attached to the casing 2 is used for fastening.

FIGS. 2 to 6 show a motor vehicle with different positions at which the scenting device 1 can be mounted. FIG. 2 shows a motor vehicle with an interior 5 and a door 6. The driver's door or a side door is shown, which is arranged at the front left of the motor vehicle. The door 6 comprises an outer surface 61 and a narrow side 62. The door handle 63 is arranged on the outer surface 61. In the closed state, the door 6 is surrounded by a door frame 7, which is part of the housing of the interior 5. A component of the door frame 7 can be, for example, the door sill 71, the A-pillar 72, the B-pillar 73, the C-pillar 74 or a boot door frame 75. When the door 6 is closed, the narrow side 62 of the door 6 and the door frame 7 of the interior 5 housing are in contact.

In the arrangement shown in FIG. 2, the scenting device 1 is arranged on the narrow side 62 of the passenger door. When the door 6 is open, the scenting device 1 is visible and easily accessible for removal. The scenting device 1 is exposed and emits scent which the user can easily perceive when entering and leaving the interior.

If the door 6 is closed because the motor vehicle is moving or parked, the scenting device 1 arranged on the narrow side 62 is covered by the door frame 7. More precisely, the scenting device 1 is covered by the B-pillar 73, which is partially part of the door frame 7. When the door 6 is closed, the scenting device 1 is trapped by the door 6 and the door frame 7, i.e., the door frame 7 presses on the surface of the scenting device 1 which is exposed when the door 6 is open. In other words, the scenting device 1 is in contact with the door 6 and the door frame 7. When the door 6 is closed, the scenting device 1 does not emit any scent. The scenting device 1 is neither visible nor accessible to persons outside the motor vehicle nor to occupants in the interior 5.

The scenting device 1 is arranged in such a way that it can be covered only by closing the door 6 and exposed only by opening the door 6. To start or stop the emission of scent, a user thus does not need to do anything other than open or close the door 6.

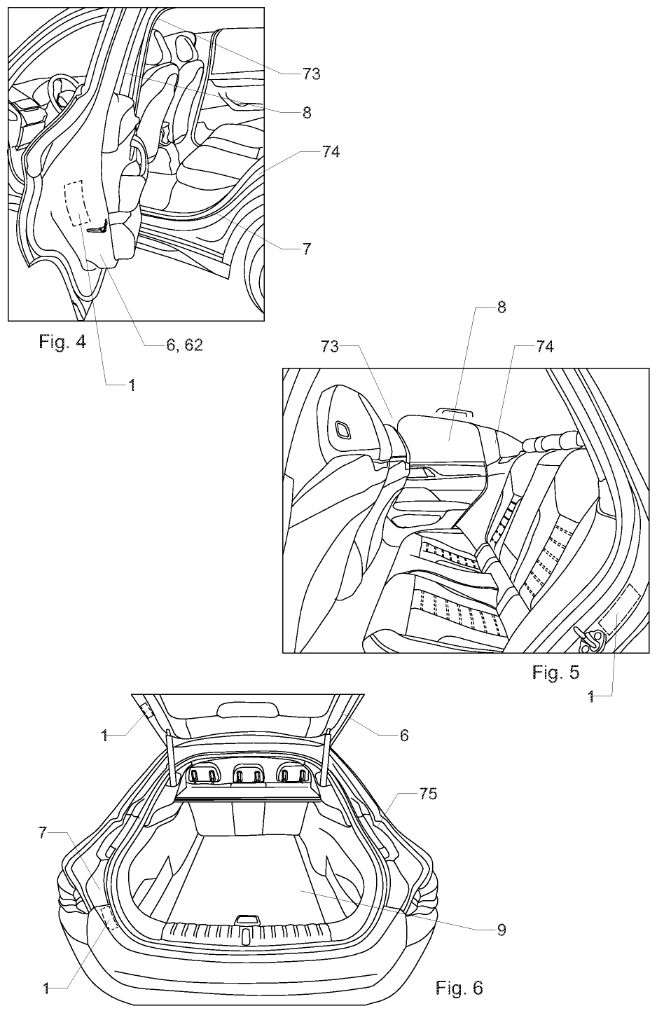

FIG. 3 shows an arrangement in which the scenting device 1 is not located on the door 6, but on the door frame 7 or on the B-pillar 72. The scenting device 1 is thus attached to a surface of the car body. When the door 6 is closed, the narrow side 62 of the door 6 presses on the surface of the scenting device 1 which is exposed when the door 6 is open. When the door 6 is open, the scenting device 1 is exposed and emits scent. If the door 6 is closed, the scenting device 1 is covered and does not emit any scent.

FIG. 4 shows an arrangement on the narrow side 62 of the door 6, which is a side door at the rear seat. FIG. 5 shows an arrangement of the scenting device 1 on the door frame 7 at the side door of the rear seat. The arrangement is analogous to the arrangement shown in FIGS. 2 and 3 for the driver's door. In particular, it is visible in FIG. 5 that the scenting device 1 is arranged on a curved surface of the door frame 7. Since the scenting device is relatively thin, it can be curved very easily.

In the arrangements according to FIGS. 2 to 5, it is visible that the scenting devices 1 are each arranged below the window 8.

FIG. 6 shows a view of the motor vehicle from the rear of the boot 9. The door 6 of the boot 9 is open. A scenting device 1 is arranged in the outer area of the door 6. Alternatively, the scenting device can also be arranged on the door frame 7. Both alternatives are shown in FIG. 6. If the door 6 of the boot 9 is arranged, the scenting device 1 is clamped by the door 6 and the door frame 7. The scenting device 1 does not emit any scent. When the user opens the door 6 of the boot 9, the scenting device 1 is exposed and the user can perceive the scent emitted by the scenting device 1.

While preferred embodiments of the invention are described in the present application, it should be clearly noted that the invention is not limited thereto and may be carried out in other ways within the scope of the following claims.

1. A motor vehicle, in particular a passenger car, comprising:
an interior,
a door,
a scenting device comprising a scent,
wherein the scenting device is arranged and designed in such a way that the scenting device emits the scent only when the door is open.

2. The motor vehicle according to claim 1, wherein the scenting device is arranged and designed in such a way that the scenting device is at least partially exposed when the door is open and is covered, in particular completely covered, when the door is closed.

3. The motor vehicle according to claim 1, wherein the scenting device is arranged and designed in such a way that the scenting device is not visible or accessible both to an occupant and to a person outside the motor vehicle when the door is closed.

4. The motor vehicle according to claim 1, wherein the scenting device is arranged and designed in such a way that:
a closing movement of the door alone covers the scenting device, and
an opening movement of the door alone exposes the scenting device.

5. The motor vehicle according to claim 1, wherein the scenting device is arranged and designed in such a way that the scenting device is both in contact with a door frame and in contact with the door when the door is closed.

6. The motor vehicle according to claim 1, wherein the scenting device is arranged on a narrow side of the door, in particular is fastened, in particular is fastened by means of adhesion, in particular by means of a double adhesive strip.

7. The motor vehicle according to claim 1, wherein the scenting device is arranged on the door frame of the motor vehicle, in particular is fastened, in particular is fastened by means of adhesion, in particular by means of a double adhesive strip.

8. The motor vehicle according to claim 1, wherein the scenting device is arranged on a surface of the car body which is covered by the door, in particular by the narrow side of the door, when the door is closed.

9. The motor vehicle according to claim 1, wherein the door is a side door or a boot door.

10. The motor vehicle according to claim 1, wherein the door has a window and the scenting device is arranged below the window.

11. A scenting device comprising a scent and having a flat shape with a thickness, in particular a constant thickness.

12. The scenting device according to claim 11, wherein the thickness is five times, in particular ten times, in particular twenty times, in particular forty times, smaller than the longest extension of the scenting device.

13. The scenting device according to claim 11, comprising a casing and a scent body which comprises the scent:
in particular wherein the casing is permeable, in particular perforated, for the scent,
in particular wherein the scent body is corrugated.

14. The scenting device according to claim 11, wherein the scenting device is elastically curvable along its longest extension up to at least a curvature of 1/100 mm-1, in particular up to a curvature of at least 1/75 mm-1, in particular up to a curvature of at least 1/50 mm-1.

15. The motor vehicle according to claim 1, wherein the scenting device has a flat shape with a thickness, in particular a constant thickness.

16. The motor vehicle according to claim 1, wherein the scenting device wherein the scenting device has a flat shape with a thickness, in particular a constant thickness, and
wherein the thickness is five times, in particular ten times, in particular twenty times, in particular forty times, smaller than the longest extension of the scenting device.

17. A method for performing maintenance work in a workshop on a motor vehicle, according to claim 1, the method comprising refilling the scent in the scenting device or replacing the scenting device.
